(19) United States
(12) Patent Application Publication
(10) Pub. No.: US 2016/0378079 A1
(43) Pub. Date: Dec. 29, 2016

(54) COMPUTING DEVICE AND ELECTRICAL DEVICE CONTROLLING METHOD

(71) Applicant: HON HAI PRECISION INDUSTRY CO., LTD., New Taipei (TW)

(72) Inventors: HOU-HSIEN LEE, New Taipei (TW); CHANG-JUNG LEE, New Taipei (TW); CHIH-PING LO, New Taipei (TW)

(21) Appl. No.: 14/749,108

(22) Filed: Jun. 24, 2015

(51) Int. Cl. G05B 15/02; G06T 7/00; G06F 3/01

(52) U.S. Cl. CPC G05B 15/02; G06F 3/013; G06T 7/0022; G06T 7/0044; G06T 2207/30201

(57) ABSTRACT

A method of controlling one or more electrical devices includes controlling a camera device to capture an image of a user. An eye area of the user in the image is identified. Once the user has been determined to have closed eyes for a predetermined time duration according to the eye area in the image, power of the one or more electrical devices is turned off via a controller, that is electrically connected to the one or more electrical devices.

### FIELD

The subject matter herein generally relates to electrical device control technology, and particularly to a computing device and a method for controlling power of electrical devices using the computing device.

### BACKGROUND

A user may fall asleep while one or more electrical devices such as a computer and/or a television are running It may result in wasting electricity.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure.

Moreover, in the drawings, like reference numerals designate corresponding parts throughout the several views.

FIG. 1 is a block diagram of one embodiment of a computing device.

FIG. 2 illustrates a diagrammatic view of an example of a position of a camera device.

FIG. 3 is a block diagram of one embodiment of functional modules of a control system.

FIG. 4A illustrates a diagrammatic view of an example of identifying a face area.

FIG. 4B illustrates a diagrammatic view of an example of identifying an eye area.

FIG. 5 illustrates a flowchart of one embodiment of a method for controlling power of one or more electrical devices.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

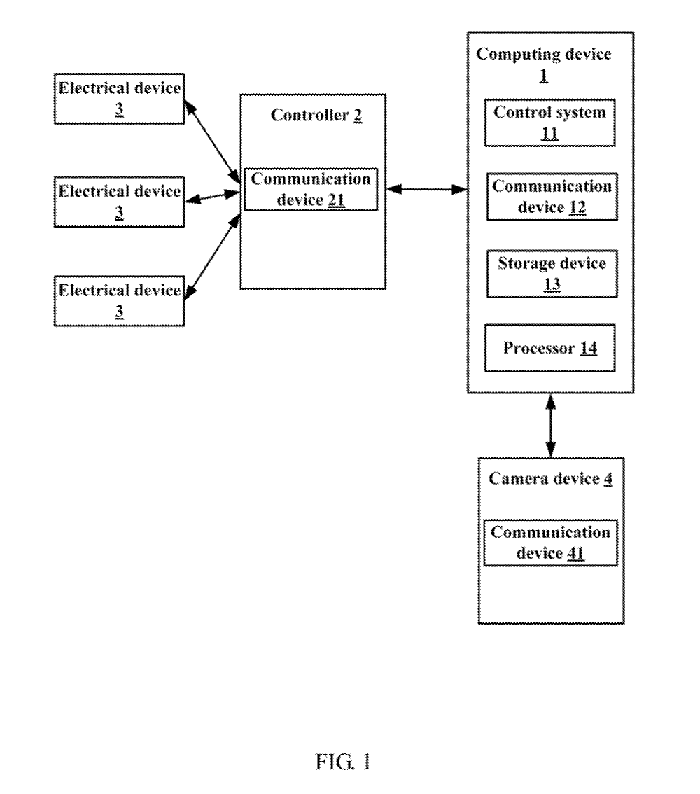

FIG. 1 is a block diagram of one embodiment of a computing device. Depending on the embodiment, a computing device 1 includes a control system 11 for controlling one or more electrical devices 3. The one or more electrical devices 3 may include, but are not limited to, one or more illumination apparatuses, one or more televisions, and/or one or more ceiling fans.

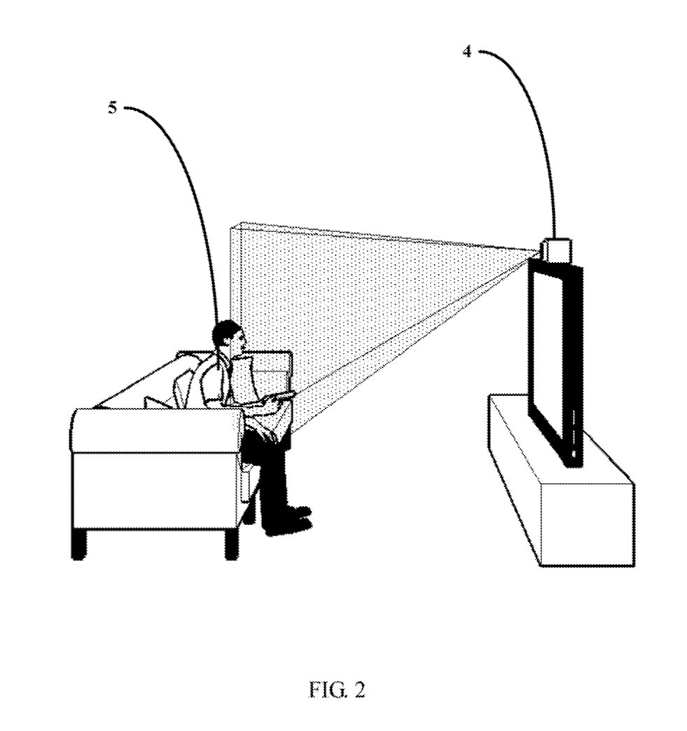

The one or more electrical devices 3 are electrically connected to a controller 2. The controller 2 is electronically connected to the computing device 1 via a communication device 21 of the controller 2 and a communication device 12 of the computing device 1. The computing device 1 is further electronically connected to a camera device 4 via the communication device 12 and a communication device 41 of the camera device 4. As shown in FIG. 2, the camera device 4 can be positioned in front of a user 5, and can capture images of the user 5.

The controller 2 can be a programmable automation controller (PAC) or a programmable logic controller (PLC). The computing device 1 may be a server or any other device that has data processing function. The communication devices 12, 21, and 41 can be BLUETOOTH devices or WIFI devices.

The computing device 1 further includes a storage device 13 and at least one processor 14. In one embodiment, the storage device 13 can be an internal storage device, such as a flash memory, a random access memory (RAM) for temporary storage of information, and/or a read-only memory (ROM) for permanent storage of information. The storage device 13 can also be an external storage device, such as an external hard disk, a storage card, or a data storage medium.

The at least one processor 14 can be a central processing unit (CPU), a microprocessor, or other data processor chip that performs functions of the computing device 1.

The control system 11 can control the one or more electrical devices 3 according to images that are captured by the camera device 4. For example, the control system 11 can turn off power to the one or more electrical devices 3, when it has been determined that the user has closed eyes for a predetermined time duration according to the images. Details will be given in the following paragraphs.

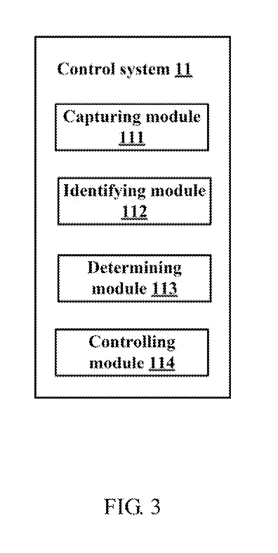

FIG. 3 is a block diagram of one embodiment of functional modules of the control system 11. In at least one embodiment, the control system 11 can include a capturing module 111, an identifying module 112, a determining module 113, and a control module 114. The function modules 111-114 can include computerized codes in the form of one or more programs, which are stored in the storage device 13, and are executed by the at least one processor 14 of the computing device 1 to provide functions of controlling the one or more electrical devices 3.

The capturing module 111 can control the camera device 4 to capture an image of the user 5.

The identifying module 112 can obtain the image and identify a face area of the user 5 in the image.

In one embodiment, the identifying module 112 can compare the image with one or more predetermined face templates. In one embodiment, the one or more predetermined face templates can be face templates of different facial expressions of the user 5. For example, the one or more predetermined face templates can be a face template of the user 5 smiling expression, and/or a face template of the user 5 with a serious expression, and etc.

When a first similarity degree between a first area of the image and one of the predetermined face templates is greater than a first preset value (e.g., 95%), the first area of the image is determined to be the face area of the user 5 in the image.

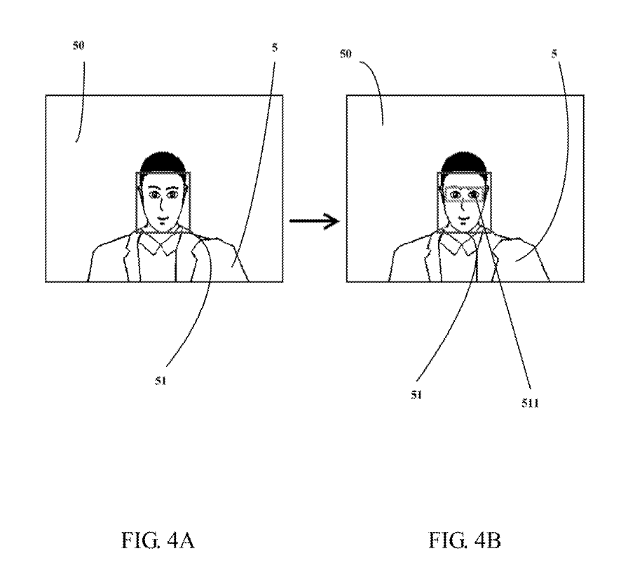

For example, as shown in FIG. 4A, the identifying module 112 can determine a first area 51 of an image 50 to be the face area of the user 5 in the image 50.

The identifying module 112 can identify an eye area of the user 5 in the image.

In one embodiment, the identifying module 112 can compare the face area of the user 5 with one or more predetermined eye templates. In one embodiment, the one or more predetermined eye templates may include, but not limited to, an eye template of the user 5 with closed eyes, an eye template of the user 5 with opened eyes.

When a second similarity degree between a second area of the face area of the user 5 in the image and one of the predetermined eye templates, is greater than a second preset value (e.g., 90%), the second area of the face area of the user 5 in the image is determined to be the eye area of the user 5 in the image.

For example, as shown in FIG. 4B, the identifying module 112 can determine a second area 511 of the first area 51 to be the eye area of the user 5 in the image 50.

The determining module 113 can determine whether the eyes of the user 5 are closed in the image, according to the eye area of the user 5 in the image.

In one embodiment, the determining module 113 can determine a total number of eyeballs in the eye area of the user 5 in the image. When the total number of eyeballs in the eye area of the user 5 in the image is determined to be equal to 0, the determining module 113 can determine that the user 5 has closed eyes. When the total number of eyeballs in the eye area of the user 5 in the image is determined to be not equal to 0, the determining module 113 can determine that the user 5 has open eyes.

In one embodiment, the determining module 113 can compare the eye area of the user 5 in the image with a first predetermined eyeball template that includes both eyeballs, and a second predetermined eyeball template that does not include any eyeballs.

When a third similarity degree between the eye area of the user 5 in the image and the first predetermined eyeball template, is greater than a third preset value (e.g., 98%), the determining module 113 can determine the total number of eyeballs in the eye area of the user 5 in the image is equal to 2.

When a fourth similarity degree between the eye area of the user 5 in the image and the second predetermined eyeball template, is greater than a fourth preset value (e.g., 98%), the determining module 113 can determine the total number of eyeballs in the eye area of the user 5 in the image is equal to 0.

The determining module 113 can further determine whether the user 5 has eyes closed for a predetermined time duration (e.g., 3 minutes).

In one embodiment, when the user 5 has been determined to have closed eyes in each of images that are captured in the predetermined time duration, the determining module 113 can determine the user 5 has eyes closed for the predetermined time duration.

For example, when the user 5 in a first image captured at “T1” is determined to have closed eyes, the user 5 is further determined to have closed eyes in each of other images that are captured from “T1” to “T2”, and the time duration between “T1” and “T2” is equal to the predetermined time duration, the determining module 113 can determine the user 5 has closed eyes for the predetermined time duration.

When the user 5 has been determined to have closed eyes for the predetermined time duration, the controlling module 114 can turn off power of the one or more electrical devices 3 via the controller 2.

In one embodiment, the controlling module 114 can send a control command to the controller 3 through the communication device 12. The controller 3 can turn off power to the one or more electrical devices 3 to save power, when the control command is received through the communication device 21.

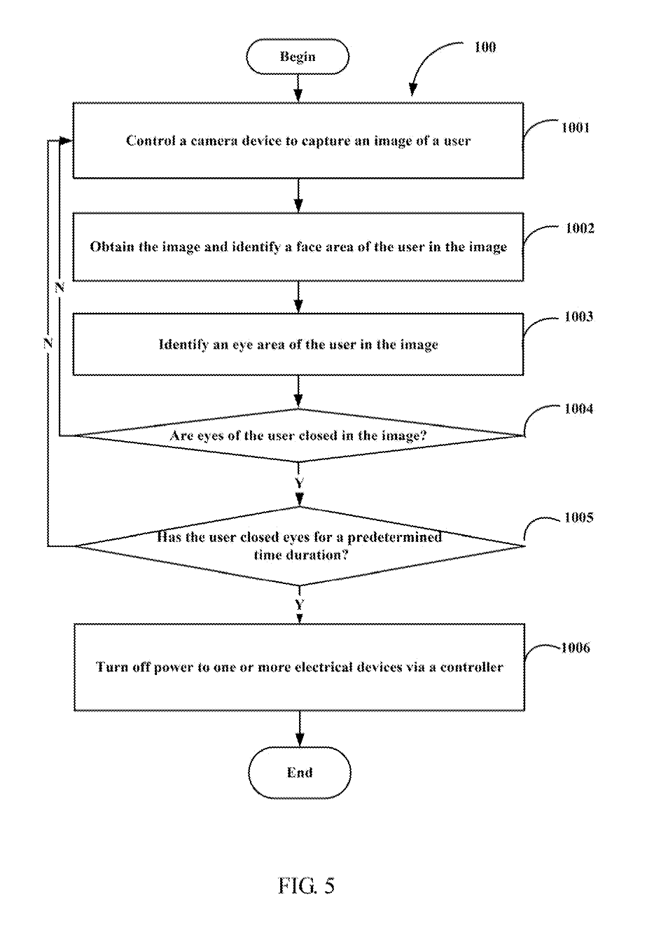

FIG. 5 illustrates a flowchart which is presented in accordance with an example embodiment. The example method 100 is provided by way of example, as there are a variety of ways to carry out the method. The method 100 described below can be carried out using the configurations illustrated in FIG. 1, for example, and various elements of these figures are referenced in explaining example method 100. Each block shown in FIG. 5 represents one or more processes, methods, or subroutines, carried out in the exemplary method 100. Furthermore, the illustrated order of blocks is by example only and the order of the blocks can be changed according to the present disclosure. The exemplary method 100 can begin at block 1001. Depending on the embodiment, additional steps can be added, others removed, and the ordering of the steps can be changed.

At block 1001, a capturing module can control a camera device that is electronically connected to a computing device to capture an image of a user.

At block 1002, an identifying module can obtain the image and identify a face area of the user in the image.

In one embodiment, the identifying module can compare the image with one or more predetermined face templates. In one embodiment, the one or more predetermined face templates can be face templates of different facial expressions of the user. For example, the one or more predetermined face templates can be a face template of the user smiling, and/or a face template of the user being serious, and etc.

When a first similarity degree between a first area of the image and one of the predetermined face templates is greater than a first preset value (e.g., 95%), the first area of the image is determined to be the face area of the user in the image.

At block 1003, the identifying module can identify an eye area of the user in the image.

In one embodiment, the identifying module can compare the face area of the user with one or more predetermined eye templates. In one embodiment, the one or more predetermined eye templates may include, but are not limited to, an eye template of the user with closed eyes, an eye template of the user with opened eyes.

When a second similarity degree between a second area of the face area of the user in the image and one of the predetermined eye templates, is greater than a second preset value (e.g., 90%), the second area of the face area of the user in the image is determined to be the eye area of the user in the image.

At block 1004, a determining module can determine whether the user has closed eyes in the image, according to the eye area of the user in the image. When the user has closed eyes in the image, the process goes to block 1005. When the user does not have closed eyes in the image, the process goes to block 1001.

In one embodiment, the determining module can determine a total number of eyeballs in the eye area of the user in the image. When the total number of eyeballs in the eye area of the user in the image is determined to be equal to 0, the determining module can determine the user has closed eyes. When the total number of eyeballs in the eye area of the user in the image is determined to be not equal to 0, the determining module can determine the user has open eyes.

In one embodiment, the determining module can compare the eye area of the user in the image with a first predetermined eyeball template that includes both eyeballs, and a second predetermined eyeball template that does not include any eyeballs.

When a third similarity degree between the eye area of the user in the image and the first predetermined eyeball template, is greater than a third preset value (e.g., 98%), the determining module can determine the total number of eyeballs in the eye area of the user in the image is equal to 2.

When a fourth similarity degree between the eye area of the user in the image and the second predetermined eyeball template, is greater than a fourth preset value (e.g., 98%), the determining module can determine the total number of eyeballs in the eye area of the user in the image is equal to 0.

At block 1005, the determining module can further determine whether the user has closed eyes for a predetermined time duration (e.g., 3 minutes). When the user has closed eyes for the predetermined time duration, the process goes to block 1006.

When the user has not closed eyes for the predetermined time duration, the process goes back to block 1001.

In one embodiment, when the user has been determined to be have closed eyes in each of images that are captured in the predetermined time duration, the determining module can determine the user has closed eyes for the predetermined time duration.

For example, when the user in a first image captured at “T1” is determined to be have closed eyes, the user is further determined to be have closed eyes in each of other images that are captured from “T1” to “T2”, and the time duration between “T1” and “T2” is equal to the predetermined time duration, the determining module can determine the user has closed eyes for the predetermined time duration.

At block 1006, When the user has been determined to close eyes for the predetermined time duration, a controlling module can turn off power of the one or more electrical devices via a controller that is electronically connected to the computing device.

In one embodiment, the controlling module can send a control command to the controller through a communication device of the computing device. The controller can turn off power to one or more electrical devices that are electrically connected to the controller to save power, when the control command is received through a communication device of the controller.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented method for controlling one or more electrical devices, the method executable by at least one processor of a computing device, the computing device communicating with a camera device and a controller, the controller electrically connecting with the one or more electrical devices, the method comprising:
controlling the camera device to capture an image of a user;
identifying an eye area of the user in the image;
determining whether the eyes of the user are closed in the image; and
turning off power to the one or more electrical devices via the controller, in event the user has closed eyes for a predetermined time duration.

2. The method according to claim 1, further comprising:
identifying a face area of the user in the image before identifying the eye area of the user in the image.

3. The method according to claim 2, wherein the face area of the user in the image is identified by:
comparing the image with one or more predetermined face templates;
identifying a first area of the image to be the face area of the user in the image, when a first similarity degree between the first area of the image and one of the predetermined face templates is greater than a first preset value.

4. The method according to claim 3, wherein the eye area is identified by:
comparing the face area of the user in the image with one or more predetermined eye templates;
determining a second area of the face area of the user in the image to be the eye area of the user in the image, when a second similarity degree between the second area of the face area of the user in the image and one of the predetermined eye templates is greater than a second preset value.

5. The method according to claim 1, wherein the user is determined to be closing eyes when a total number of eyeballs in the eye area is equal to 0.

6. The method according to claim 1, wherein when the user is determined to be closing eyes in each of images that are captured in the predetermined time duration, the user is determined to has closed eyes for the predetermined time duration.

7. The method according to claim 1, further comprising:
sending a control command to the controller when the user has closed eyes for the predetermined time duration, wherein the controller turns off the power of the one or more electrical devices when the control command is received.

8. A computing device comprising:
at least one processor;
a storage device that stores images, the storage device being configured to store one or more programs that, when executed by the at least one processor, cause the at least one processor to:
control a camera device that is connected to the computing device to capture an image of a user;
identify an eye area of the user in the image;
determine whether the eyes of the user are closed in the image; and
turn off power to one or more electrical devices via a controller when the user has closed eyes for a predetermined time duration, wherein the one or more electrical devices are electrically connected to the controller.

9. The computing device according to claim 8, wherein the at least one processor further:
identifying a face area of the user in the image before identifying the eye area of the user in the image.

10. The computing device according to claim 9, wherein the face area of the user in the image is identified by:
comparing the image with one or more predetermined face templates;
identifying a first area of the image to be the face area of the user in the image, when a first similarity degree between the first area of the image and one of the predetermined face templates is greater than a first preset value.

11. The computing device according to claim 10, wherein the eye area is identified by:
comparing the face area of the user in the image with one or more predetermined eye templates;
determining a second area of the face area of the user in the image to be the eye area of the user in the image, when a second similarity degree between the second area of the face area of the user in the image and one of the predetermined eye templates is greater than a second preset value.

12. The computing device according to claim 8, wherein the user is determined to be closing eyes when a total number of eyeballs in the eye area is equal to 0.

13. The computing device according to claim 8, wherein when the user is determined to be closing eyes in each of images that are captured in the predetermined time duration, the user is determined to has closed eyes for the predetermined time duration.

14. The computing device according to claim 8, wherein the at least one processor further:
sending a control command to the controller when the user has closed eyes for the predetermined time duration, wherein the controller turns off the power of the one or more electrical devices when the control command is received.

15. A non-transitory storage medium having stored thereon instructions that, when executed by a processor of a computing device, causes the processor to perform a method for controlling one or more electrical devices that are electrically connected to a controller, the controller being electronically connected to the computing device, wherein the method comprises:
controlling a camera device that is electronically connected to the computing device to capture an image of a user;
identifying an eye area of the user in the image;
determining whether the eyes of the user are closed in the image; and
turning off power to the one or more electrical devices via the controller, when the user has closed eyes for a predetermined time duration.

16. The non-transitory storage medium according to claim 15, wherein the method further comprises:
identifying a face area of the user in the image before identifying the eye area of the user in the image.

17. The non-transitory storage medium according to claim 16, wherein the face area of the user in the image is identified by:
comparing the image with one or more predetermined face templates;
identifying a first area of the image to be the face area of the user in the image, when a first similarity degree between the first area of the image and one of the predetermined face templates is greater than a first preset value.

18. The non-transitory storage medium according to claim 17, wherein the eye area is identified by:
comparing the face area of the user in the image with one or more predetermined eye templates;
determining a second area of the face area of the user in the image to be the eye area of the user in the image, when a second similarity degree between the second area of the face area of the user in the image and one of the predetermined eye templates is greater than a second preset value.

19. The non-transitory storage medium according to claim 15, wherein the user is determined to be closing eyes when a total number of eyeballs in the eye area is equal to 0.

20. The non-transitory storage medium according to claim 15, wherein when the user is determined to be closing eyes in each of images that are captured in the predetermined time duration, the user is determined to has closed eyes for the predetermined time duration.
